(19) United States
(12) Patent Application Publication
(10) Pub. No.: US 2004/0135895 A1
(43) Pub. Date: Jul. 15, 2004

(54) Method and apparatus for producing homogenized image data for scanning imagers

(76) Inventor: Wolfgang Wiedmann, Essingen (DE)

Correspondence Address: BURNS DOANE SWECKER & MATHIS L L P, POST OFFICE BOX 1404, ALEXANDRIA, VA, 22313-1404, US

(21) Appl. No.: 10/722,149

(22) Filed: Nov. 24, 2003

(30) Foreign Application Priority Data
Nov. 25, 2002 (DE) 102 55 021.2-31

(51) Int. Cl. H04N 5/225

(52) U.S. Cl. 348/216.1

(57) ABSTRACT

The invention relates to the production of image data, wherein a scene is scanned with a detector (1) which has a large number of sensor elements for producing image signals. An overall value is formed (unit 12) for each of the sensor elements, which represents a totality of image signals obtained from that sensor element, so that an overall value profile is obtained at least over a part of the scanned scene. The overall values for adjacent sensor elements are used to determine whether differences between these overall values satisfy a predetermined magnitude criterion which indicates inhomogeneities in signal sensitivities of these sensor elements (unit 14). If the magnitude criterion is satisfied, the image signals are corrected (unit 15) such that the magnitude criterion is no longer satisfied. The image data is produced from the corrected image signals or from the image signals which do not satisfy the magnitude criterion and is displayed on a screen (4).

### RELATED APPLICATIONS

This patent application claims priority to German Patent Application No. 102 55 021.2-31 filed Nov. 25, 2003, entitled “Method and Apparatus for Producing Homogenized Image Data for Scanning Imagers”.

### DESCRIPTION

The invention relates to a method and an apparatus for producing image data of a scene, wherein the scene is scanned with a detector. The invention relates in particular to the production of an image of infrared radiation from the scene (thermal image).

Scanning imagers have a detector with a multiplicity of sensor elements which, in one conventional embodiment, are arranged alongside one another in a row. Particularly in the case of devices for producing thermal images, the individual sensor elements have pronouncedly different signal sensitivities, that is to say they emit image signals of different magnitude when the same radiation strikes the sensor element. The image signals are normally electrical voltages which, for example, can be converted on a screen to pixels or image areas with brightness and/or colour corresponding to the voltage.

EP 0 600 742 A1 describes a sensor system having a sensor which has an array of detector elements. The sensor is mounted on a sensor positioning unit, by means of which the position of the sensor can be varied. A signal processor continuously corrects the intensities of pixels from a sensor output array, with regard to inhomogeneity of the detector elements.

One conventional method for describing the dependency of the intensity of the output signal on the incident radiation for an individual sensor element is based on a linear approach. The signal sensitivity is uniquely described by a constant (offset) and by a gain factor at a specific operating point which, for example, is characterized by the temperature of a grey radiation source which emits the radiation that strikes the sensor element. This is a sufficiently accurate approach in a sufficiently narrow area around the operating point. The different signal sensitivity of the individual sensor elements is thus expressed as different offset and gain values which generally also still depend on the operating point.

One possible way to compensate for the different signal sensitivity is to couple the emitted radiation from a controllable radiation source into the beam path after each scan of the scene, so that the same radiation strikes each of the sensor elements. Since the temperature of the radiation source is regulated at the average scene temperature, this reference measurement takes place at a suitable operating point. Correction values for each of the sensor elements can thus be determined. The outlay for producing the reference radiation and for coupling the reference radiation into the beam path is, however, high.

A further possibility is to carry out reference measurements at different operating points and relatively long time intervals, and to store the offset and gain values for all the sensor elements for one or more operating points, so that they can subsequently be used for correction of the image signals. The disadvantages of this method are that the signal sensitivities of the sensor elements vary during use and/or with time, and repeated reference measurements are complex.

An object of the present invention is to make it possible to take account of inhomogeneities in the signal sensitivities of the sensor elements with a high degree of accuracy and with as little complexity as possible for reference measurements.

In order to achieve the object, the invention proposes that an overall value be formed for each of the sensor elements, which overall value represents a totality of image signals obtained from that sensor element, so that an overall value profile is obtained at least over a part of the scanned scene. The overall values for adjacent sensor elements are used to determine whether differences between these overall values satisfy a predetermined magnitude criterion which indicates inhomogeneities in signal sensitivities of these sensor elements.

The invention relates in particular to devices for producing thermal images having a detector whose sensor elements are arranged as an array in the form of a row. However, it is not restricted to appliances such as these. The invention is particularly highly suitable for scanning imagers which are operated in such a way that the ratio of the number of sensor elements to the number of pixels obtained from these sensor elements in a single scanning process is large. This is generally the case for detectors and imagers with only one row or with only a small number of rows of sensor elements.

The overall value which represents the totality of the image signals from the respective sensor element is, for example, a sum value, the value of an integral over the area of the scene (or over a subarea of it) which is covered by the sensor elements, a mean value or a value derived from these values. It is also possible to combine two or more of these values and/or of the derived values to form the overall value.

Depending on the nature of the scanning method, the area of the scene that is covered by a sensor element is of a different type, for example a row or a column, a pair of rows or a group of subareas which are independent of one another.

The invention is based on the idea that mutually adjacent sensor elements should generally produce similar output signals. This statement is more valid the denser the areas covered by the adjacent sensor elements are to one another, or the greater the extent to which they overlap one another, and the greater the areas covered. A correction for the inhomogeneities of the sensor elements can thus be carried out continuously during production of the image. No complex reference measurements are thus required in any case during production of the image. Any gradual change to the signal sensitivities is corrected. In comparison to methods in which reference measurements are carried out repeatedly, it is possible to achieve the same accuracy, or even better accuracy, in the correction process.

The overall values are preferably formed and evaluated for all the available sensor elements. However, this is not absolutely necessary. Depending on whether the areas of the scene which are covered by the individual sensor elements overlap or whether the density or number of the sensor elements is sufficiently large in comparison to the desired image resolution, it is possible, for example, to form or evaluate only the overall values of every second or third (formulated in general terms: every n-th) sensor element. It is also possible to vary the density of the evaluation over the scene, for example forming or evaluating the overall values of more sensor elements in a central area of the scene than in edge areas.

If the magnitude criterion is satisfied, the invention also proposes that the image signals be corrected such that the magnitude criterion is no longer satisfied in the case of the corrected image signals. The desired image data is thus produced either from the image signals which do not satisfy the magnitude criterion or from the corrected image signals. In this case, the image signals which do not satisfy the magnitude criterion may be image signals which have already been corrected in some other way, and/or which have been corrected in advance.

In one particularly preferred embodiment, a first correction of the image signals is carried out for correction of the signal sensitivities, and predetermined correction values, which are associated with the sensor elements, are used for this purpose. For example, these correction values are the result of a reference measurement of the type mentioned above that was carried out previously. The magnitude criterion is then applied to the image signals which have already been corrected once. At least one further correction value, which is associated with a sensor element, is determined if the magnitude criterion is satisfied, and a second correction is carried out using the at least one further correction value, such that the magnitude criterion is no longer satisfied. It is thus possible, for example, to carry out a first, rough correction, and a fine correction can be carried out if required by using the magnitude criterion. This embodiment allows particularly accurate correction. Furthermore, the complexity overall is low, since recorrections need to be carried out only when required.

The at least one correction value which is determined using the magnitude criterion can be stored such that it is associated with the corresponding sensor element. During subsequent scanning processes, the at least one correction value can be used once again for recorrection, and/or can be changed after application of the magnitude criterion. In this case, however, a range of application is preferably checked, and the at least one correction value is not used when the range of application is left. For example, the at least one correction value applies only to a defined range around an operating point, that is to say around a value of the average scene temperature.

The expression adjacent sensor elements means not only immediately adjacent sensor elements. In fact, for example, it is worthwhile when checking the magnitude criterion to consider in each case, for example, the 4, 6 or 8 closest sensor elements (in general: the i closest sensor elements, where i is an integer) to one or more or all of the sensor elements.

The magnitude criterion may comprise one or more evaluations of the differences. For example, it comprises the check whether the overall value of a specific sensor element is an extreme in a vicinity of the sensor element, whether any difference between the overall value of a specific sensor element and the overall value of an adjacent sensor element is greater than a predetermined limit value or is greater than a limit value which is determined from a predetermined value and from the overall value profile, and/or whether the local derivative of the overall value reaches or exceeds a predetermined level at the location of a specific sensor element.

If the magnitude criterion is satisfied, a check is optionally also carried out to check whether a measure for a totality of possible correction values for correction of the image signals differs from zero or from a measure for a totality of other correction values by more than a predetermined amount. The measure for the totality is, for example, a sum value, a mean value and/or a value derived therefrom.

This makes it possible to prevent subareas of the image to be produced or even the entire image having its overall intensity changed by the correction. If an unacceptable correction such as this is found, the correction is either not carried out or the correction values are appropriately adapted, for example with all the correction values being increased or decreased in the respective subarea.

For an apparatus for producing image data of a scene, the invention proposes that the following be provided:

a detector for scanning the scene, which has a multiplicity of sensor elements for producing image signals,

a unit for forming overall values, which is configured such that it forms an overall value for each of the sensor elements which overall value represents a totality of image signals obtained from the sensor element, such that an overall value profile is obtained over at least a part of the scanned scene,

a unit for checking a magnitude criterion, wherein the unit is configured such that it uses the overall values of adjacent sensor elements to determine whether differences between these overall values satisfy a predetermined magnitude criterion which indicates inhomogeneities in signal sensitivities of these sensor elements,

a unit for correction of the image signals, wherein the unit is configured such that, when the magnitude criterion is satisfied, it corrects the image signals such that the magnitude criterion is no longer satisfied, and

a unit for producing the image data, which unit is configured such that it produces the image data from the corrected image signals or from the image signals which do not satisfy the magnitude criterion.

The apparatus may also have a memory device for storing a first set of correction values for correction of the image signals, and may also have a unit for determining at least one second correction value in order to change the first set of correction values. This makes it possible to carry out a correction in the same way for each scanning process, that is to say using a set of correction values stored in the memory device. This set of correction values is corrected if required. If the scanning frequency is sufficiently high, the set of correction values is effectively changed only during the correction of the next or even of a subsequent scan, without having to accept any visible loss of quality. This has the advantage that there is no additional delay in the production of the image data.

The invention will be explained in more detail in the following text with reference to exemplary embodiments which are illustrated schematically in the figures. Identical reference numbers in the individual figures in this case denote the same or functionally identical elements. In detail:

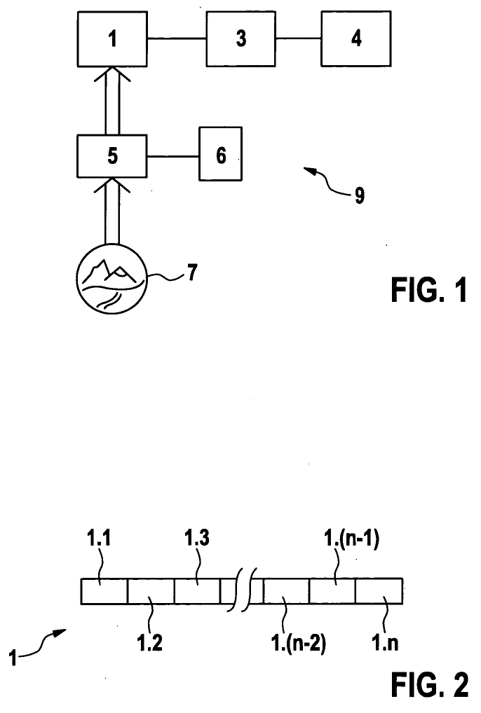

FIG. 1 shows a scene to be scanned and a scanning apparatus,

FIG. 2 shows a detector having a multiplicity of sensor elements which are arranged alongside one another in a row,

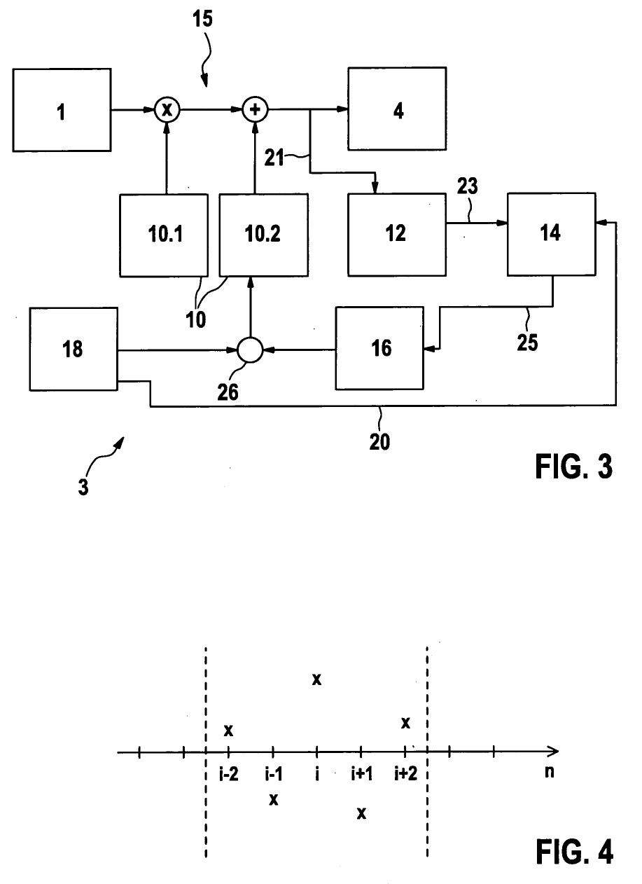

FIG. 3 shows an image generating device with a screen connected to it,

FIG. 4 shows five overall values which are each associated with one of the sensor elements shown in FIG. 2, and

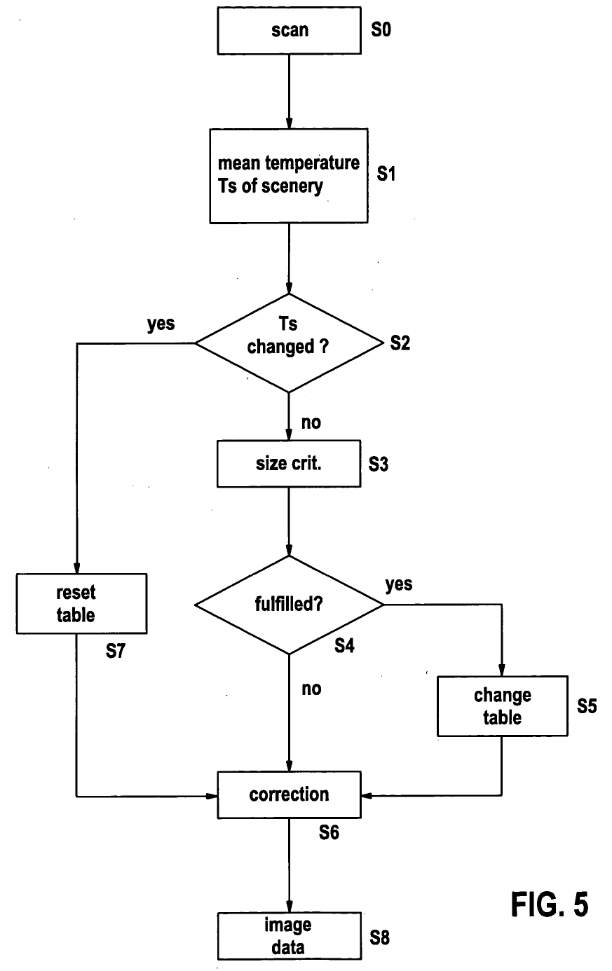

FIG. 5 shows a flowchart.

In FIG. 1, a scanning apparatus 9 receives electromagnetic radiation from a scene 7 to be scanned (lower broad arrow pointing upwards). The scanning apparatus 9 is, in particular, a device for producing thermal images, that is to say an arrangement which is sensitive to infrared radiation and which produces a visible image corresponding to the incident infrared radiation, in particular on a screen 4. The electromagnetic radiation strikes an optical device 5 which, for example, has a mirror with a moveable orientation.

The scanning process is controlled by a controller 6, for example by continuously varying the orientation of the mirror, so that the area of the scene 7 to be scanned is covered. At any moment during the scanning process, the electromagnetic radiation strikes sensor elements 1.1 to 1.n of a detector 1 (upper broad arrow pointing upwards). As FIG. 2 shows, the sensor elements 1.1 to 1.n form a sensor row with n elements, where n is a positive integer, for example 512. Each of the sensor elements 1.1 to 1.n has an individual signal sensitivity, that is to say the sensor elements react differently to the same incident electromagnetic radiation. The sensor elements 1.1 to 1.n each continuously produce an image signal, which is transmitted from the detector 1 to an image generating apparatus 3. The image generating apparatus 3 in turn produces image data, which is converted to a visible image on the screen 4.

FIG. 3 shows major parts of one particularly preferred embodiment of the image generating apparatus 3 with the detector 1 that is connected to it, and with the screen 4. The image generating device 3 has a first correction value memory. 10, which has two memory elements 10.1 and 10.2. A gain correction value is stored in the memory element 10.1 for all of the sensor elements 1.1 to 1.n. An offset correction value is stored in the memory element 10.2 for all of the sensor elements 1.1 to 1.n. The memory elements 10.1 and 10.2 are each connected to a correction device 15, in which the image signals received from the detector 1 are first of all (as is indicated by an “x” in a circle) each multiplied by the associated gain correction value for the sensor element 1.1 to 1.n, and the associated offset correction value for the sensor element 1.1 to 1.n is then added to this (as indicated by a “+” in a circle). The output signals from the correction device represent the image data, and are supplied on the one hand to the screen 4 and on the other hand via a signal line 21 to an overall value formation unit 12.

The overall value formation unit 12 is designed to form an overall value of all of the image signals produced during a single scanning process over the scene 7, for each of the sensor elements 1.1 to 1.n. Alternatively, the overall values may also be formed for only a portion of the scanning process. For example, the overall values are in each case equal to the integral of the image signal of the associated sensor element 1.1 to 1.n over the time of the scanning process. A profile of the overall values over the sensor elements 1.1 to 1.n of the detector 1 is thus available as an output signal in the overall value formation unit 12. The overall value formation unit 12 is connected via a signal line 23 to a homogeneity checking unit 14. The output signal is thus available there. As will be described later, the homogeneity checking unit 14 uses the overall value profile to check whether any inhomogeneity in the signal sensitivities of the sensor elements 1.1 to 1.n can be detected beyond the correction and/or preprocessing of the image signals already carried out. As will likewise be explained later, the homogeneity checking unit 14 also receives a signal from a second correction value memory 18, in which an offset correction value is stored for each of the sensor elements 1.1 to 1.n. The signal corresponds to an overall value, in particular to a mean value or sum value, of the correction values in the second correction value memory 18. For this purpose, the second correction value memory 18 is connected via a signal line 20 to the homogeneity checking unit 14.

A signal output of the homogeneity checking unit 14 is connected via a signal line 25 to a signal input of a fine correction value memory 16. If the magnitude criterion, which is checked in the homogeneity checking unit 14, is satisfied, signals are transmitted via this signal line 25, leading to a change of at least one of the fine correction values, which are stored in the fine correction value memory 16 for each of the sensor elements 1.1 to 1.n.

Furthermore, a combination device 26 is provided and is connected, in each case via signal lines, on the input side to the second correction value memory 18 and to the fine correction value memory 16, and on the output side to the second memory element 10.2 of the first correction value memory 10. The combination device 26 in each case combines the fine correction values from the fine correction value memory 16 and offset correction values from the second correction value memory 18, which are associated with one of the sensor elements 1.1 to 1.n, and outputs them to the second memory element 10.2. The output combination, in particular a sum of the values, replaces the corresponding offset correction value, which was previously stored there, in the second memory element 10.2

FIG. 5 shows a flowchart of the production of image data, some of which takes place in the image generating device 3 described with reference to FIG. 3. A scene is scanned once in step S0, for example by means of the scanning apparatus 9 illustrated in FIG. 1. After this single scan, the mean scene temperature Ts is first of all determined in step S1, for example by means of a unit (which is not illustrated in FIG. 3) of the image generating apparatus 3 or by means of the overall value formation unit 12. The corresponding unit is connected via a control line (which is not illustrated in FIG. 3) to the fine correction value memory 16 and, optionally, to the second correction value memory 18, in order to make it possible to set the stored correction values to a defined initial state.

Step S2 determines whether the mean scene temperature Ts has changed from an immediately preceding scan. If this is the case, the process continues with step S7. If this is the first scan after starting or resetting of the scanning apparatus, the process likewise continues with step S7. Otherwise, the process continues with step S3.

In step S7, the offset correction values in the fine correction value memory 16 are set to zero, and the offset correction values from the second correction value memory 18 are loaded via the combination device 26 into the second memory element 10.2 of the first correction value memory 10. This resetting of the values in the fine correction value memory 16 takes account of the fact that a change in the scene temperature Ts also results in a change in the operating point and, at least when using a linear approach for the correction of the image signals, the fine correction values are no longer valid.

In a preferred, alternative embodiment, however, the fine correction values which are determined from operation of the scanning apparatus are stored for each operating point or for each operating range, and the stored fine correction values are loaded in the fine correction value memory 16 when the operating point changes.

A bandwidth can be preset for the question that is asked in step S2. If the current value of the scene temperature Ts is within the bandwidth around the previous value of the scene temperature Ts, the process continues with step S3.

Step S7 is followed by step S6, in which the image signals are corrected. The corrected image signals are then used in step S8 to produce the image data. The process can start with step S0 once again, after step S8.

The magnitude criterion is applied in step S3, and a check is carried out in step S4 to determine whether the magnitude criterion is satisfied. Appropriate examples will be described in more detail. If the magnitude criterion is satisfied, the correction values are changed such that the magnitude criterion is no longer satisfied (step S5). If the magnitude criterion is not satisfied, step S4 is followed immediately by step S6.

In contrast to the situation illustrated in FIG. 5, the image signals may also be corrected in two or more stages. In a first stage, the image signals can be corrected using the current correction values which, for example, are stored in the first correction value memory 10. Depending on whether the magnitude criterion is satisfied, the image signals can then be recorrected in a second stage, or if the magnitude criterion is still satisfied in at least one further stage, using the fine correction values or taking into account the fine correction values.

It is also possible, in contrast to the situation illustrated in FIG. 5, for the correction values or fine correction values to be changed if the magnitude criterion is satisfied, but for the changed values to be used only for correction of the next subsequent scan, or for a later scan. In this situation, step S6 can be carried out before step S3.

In one preferred embodiment, a multiplicity of correction value sets are stored in the second correction value memory 18, in each case for one operating point or one operating range. The respective correction value set that corresponds to the scene temperature Ts is selected and loaded in step S7.

FIG. 4 will now be used to explain one example of the process of checking whether the overall value profile indicates inhomogeneities in the signal sensitivities of the sensor elements 1.1 to 1.n. The figure uses crosses to show the overall values for five sensor elements located alongside one another. The letter i denotes the ordinal number of the central one of the five sensor elements. This illustration corresponds to one preferred embodiment of the check, in which the same number of subsequent sensor elements are considered in an individual check of the magnitude criterion, for each of the sensor elements 1.1 to 1.n on each of the two sides. In the situation illustrated in FIG. 4, there are two further sensor elements i−2, i−1 and i+1, i+2 on each of the two sides of the sensor element i.

The overall value for the sensor element i is a maximum in the area under consideration. Furthermore, the difference between this and the overall values for the sensor elements i−1 and i+1 is particularly large. This indicates that the image signals from the sensor element i should be corrected or recorrected. Formulated in a more general manner, the check comprises, for example, the following steps:

A check is carried out to determine whether the overall value for the sensor element under consideration is an extreme in its surrounding area.

The differences between the overall values for each of the closest adjacent sensor elements are determined in the surrounding area.

The maximum difference is determined.

The arithmetic mean value of the differences is determined.

The results from these steps make it possible to determine whether a correction is to be carried out. Further criteria, characteristic variables, limit values or constants may also be taken into account in this process. For example the following conditions are used to determine whether a correction should be carried out to the offset correction value for the sensor element i:

A correction is carried out only when the overall value is an extreme in the surrounding area.

A correction is carried out only when the differences between the overall values for the sensor elements i−1 and i as well as for the sensor elements i and i+1 are greater than a predetermined first constant multiplied by the arithmetic mean value of the differences.

A correction is carried out only when the differences between the overall values for the sensor elements i−1 and i as well as for the sensor elements i and i+1 are greater than a predetermined second constant multiplied by the second greatest difference between the overall values in the surrounding area.

If all of these conditions are satisfied, a check is also preferably carried out to determine whether corresponding adaptation of the offset correction value in the surrounding area changes the mean value of the offset correction values by a predetermined limit value or by more than a predetermined limit value. The changed offset correction value is only accepted and used for correction of the image signals if this is not the case. In the exemplary embodiment described with reference to FIG. 3, the homogeneity checking unit 14 is for this reason connected via the signal line 20 to the second correction value memory 18. The unit 14 thus has access to the correction values in the memory 18, which cannot be changed, and can thus reliably preclude systematic falsification in subareas of the scanned scene.

1. Method for producing homogenized image data of a scene, wherein
the scene is scanned with a detector which has a multiplicity of sensor elements for producing image signals,
an overall value is formed for each of the sensor elements, which overall value represents a totality of image signals obtained from one of the sensor elements, so that an overall value profile is obtained at least over a part of the scanned scene,
the overall values for adjacent sensor elements are used to determine whether differences between these overall values satisfy a predetermined magnitude criterion which indicates inhomogeneities in signal sensitivities of these sensor elements,
if the magnitude criterion is satisfied, the image signals are corrected such that the magnitude criterion is no longer satisfied, and
the image data is produced from the corrected image signals or from the image signals which do not satisfy the magnitude criterion.

2. Method according to claim 1, wherein a first correction of the image signals is carried out for correction of the signal sensitivities, and predetermined correction values, which are associated with the sensor elements, are used for this purpose, wherein the magnitude criterion is applied after the first correction, wherein at least one further correction value, which is associated with a sensor element, is determined if the magnitude criterion is satisfied, and wherein a second correction is carried out using the at least one further correction value, such that the magnitude criterion is no longer satisfied.

3. Method according to claims 1, wherein a process of determining whether the magnitude criterion is satisfied includes a check as to whether the overall value of a specific sensor element is an extreme in the vicinity of the sensor element.

4. Method according to claim 1, wherein processes of determining whether the magnitude criterion is satisfied include a check as to whether any difference between the overall value of a specific sensor element and the overall value of an adjacent sensor element is greater than a predetermined limit value or is greater than a limit value which is determined from a predetermined value and from the overall value profile.

5. Method according to claim 1, wherein, if the magnitude criterion is satisfied, it is checked as to whether a measure for a totality of possible correction values for correction of the image signals differs from zero or from a measure for a totality of other correction values by more than a predetermined amount.

6. Apparatus for producing homogenized image data of a scene, having:
a detector for scanning the scene, which detector has a multiplicity of sensor elements for producing image signals,
a unit for forming overall values, which is configured such that it forms an overall value for each of the sensor elements which overall value represents a totality of image signals obtained from the sensor element, such that an overall value profile is obtained over at least a part of the scanned scene,
a unit for checking a magnitude criterion, wherein the unit is configured such that it uses the overall values of adjacent sensor elements to determine whether differences between these overall values satisfy a predetermined magnitude criterion which indicates inhomogeneities in signal sensitivities of these sensor elements,
a unit for correction of the image signals, wherein the unit is configured such that, when the magnitude criterion is satisfied, it corrects the image signals such that the magnitude criterion is no longer satisfied, and
a unit for producing the image data, which unit is configured such that it produces the image data from the corrected image signals or from the image signals which do not satisfy the magnitude criterion.

7. Apparatus according to claim 6, wherein the apparatus has a memory device for storing a first set of correction values for correction of the image signals, and has a unit for determining at least one second correction value in order to change the first set of correction values.

8. Apparatus according to claim 7, wherein the apparatus has a second memory device for storing a third set of correction values, and wherein the apparatus can be controlled such that the third set of correction values can be transferred to the first memory device.

9. Scanner having an apparatus according to one of claims 6 to 8, wherein the scanner has a unit for displaying the image data produced by the apparatus.
